(19) United States
(12) Patent Application Publication
(10) Pub. No.: US 2009/0181265 A1
(43) Pub. Date: Jul. 16, 2009

(54) ENERGY MANAGEMENT MODULE AND DRIVING DEVICE

(75) Inventors: Chiang-Wen Lai, Taoyuan County (TW); Yu-Chun Ko, Taoyuan County (TW); Yu-Chih Lin, Taoyuan County (TW); Jiun-Ming Chen, Taoyuan County (TW)

Correspondence Address: QUINTERO LAW OFFICE, PC, 2210 MAIN STREET, SUITE 200, SANTA MONICA, CA, 90405, US

(73) Assignee: NAN YA PCB CORP., TAOYUAN COUNTY (TW)

(21) Appl. No.: 12/114,610

(22) Filed: May 2, 2008

(30) Foreign Application Priority Data
Jan. 15, 2008 (TW) TW97101467

(51) Int. Cl. H01M 16/00

(52) U.S. Cl. 429/9

(57) ABSTRACT

A driving device for driving a load is disclosed, including a secondary cell, a fuel cell, a fuel supply device, and an energy management module. The energy management module is coupled to the secondary cell, the fuel cell, and the fuel supply device for generating a current signal to the load and a first and a second signal to the fuel supply device according to an electrical signal and a liquid level signal of the fuel cell, and driving the fuel supply device to supply a fuel solution to the fuel cell.

### BACKGROUND OF THE INVENTION

1. Field of the Invention

The invention relates to a driving device, and more particularly to a driving device comprising a fuel cell and an energy management module used therein.

2. Description of the Related Art

Fuel cells are widely used in domestic backup power systems, transportable power systems, or portable electronic devices. Each fuel cell comprises a Membrane Electrode Assembly (MEA). When a fuel comprising a fixed concentration is provided to the anode of the MEA and appropriate oxygen is provided to the cathode of the MEA, a potential difference between the anode and the cathode is generated due to a chemical reaction. Thus, allowing the fuel cell to provide current to an external load. Since product of the fuel cell comprises carbon dioxide and water, organic matter is not generated. Thus, fuel cells are environmentally friendly. Conventional fuel cells include direct methanol fuel cell (DMFC) which uses methanol aqueous solutions as fuels for electricity-generation.

However, the concentration of the methanol aqueous solution used in conventional DMFCs is controlled under a predetermined value to prevent methanol crossover therein which may decrease the electricity-generation efficiency of the MEA therein. This predetermined value of the methanol aqueous solution depends on the property of the MEA used in the DMFC and is typically not more than 10% (vol %). In addition, the DMFC is easily affected by operation temperatures and environment temperatures, and the electricity-generation efficiency may be decreased if operation temperatures or the environment temperatures there of are too high (typically over a temperature of 60° C).

Reactions in a DMFC occur according to the following formulas (1) to (3).

At the anode: CH₃OH+H₂O→6H⁺+6e⁻+CO₂ (1)

At the cathode: 1.5 O₂+6H⁺+6e⁻→3H₂O (2)

Overall reaction: CH₃OH+1.5O₂→CO₂+2H₂O (3)

It is known from the overall reaction that water is generated during operation of the DMFC. However, water may be evaporated during reactions and the amount of water evaporated may more than generation thereof during the DMFC operation due to factors such as surrounding temperatures and operation temperatures. Moreover, the amount of the methanol in the methanol aqueous solution is reduced when reaction time of the DMFC increases and a concentration of the methanol aqueous solutions thereby decreases when reaction times increases. If the concentration of the methanol aqueous solution is too low, the hydrogen protons generated at the anode decreases and amounts of the methanol and the water is required to be increased to maintain continuous chemical reaction in the DMFC, thereby maintaining continuous operation of the DMFC.

### BRIEF SUMMARY OF THE INVENTION

Driving devices and energy management modules are provided.

An exemplary driving device for driving a load comprises a secondary cell, a fuel cell, a fuel supply device, and an energy management module coupled to the secondary cell, the fuel cell, and the fuel supply device for generating a current signal to the load and a first and a second signal to the fuel supply device according to an electrical signal and a liquid level signal of the fuel cell. The energy management module drives the fuel supply device to supply a fuel solution to the fuel cell.

An exemplary energy management module coupled to a secondary cell, a fuel cell and a fuel supply device for driving a load and supplying the fuel cell is provided, comprising a processing unit, and a temperature sensing unit, wherein the temperature sensing unit provides the processing unit a temperature signal according to a temperature state of the fuel cell and the processing unit generates a first and a second signal to the fuel supply device according to the electrical signal, the liquid level signal and the temperature signal of the fuel cell.

Another exemplary driving device for driving a load is provided, comprising a secondary cell, a fuel cell, a fuel supply device, and an energy management module coupled to the secondary cell, the fuel cell, and the fuel supply device and generating a current signal to the load. The driving device generates a first and a second signal to the fuel supply device according to a fuel concentration signal and a liquid level signal from the fuel cell, driving the fuel supply device to provide fuel supply to the fuel cell.

Another exemplary energy management module coupled to a secondary cell, a fuel cell and a fuel supply device for driving a load and supplying the fuel supply device is provided, comprising a processing unit for generating a first and a second signal to the fuel supply device according to a fuel concentration signal and a liquid level signal from the fuel cell.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of an exemplary embodiment of a driving system;

FIG. 2 is a schematic diagram of an exemplary embodiment of a driving device;

FIG. 3 is a schematic diagram of an exemplary embodiment of an energy management module;

FIG. 4 is a schematic diagram of an exemplary embodiment of a fuel cell;

FIG. 5 is a schematic diagram of an exemplary embodiment of a fuel supply device;

FIG. 6 is a schematic flowchart of an exemplary control method;

FIG. 7 is a schematic flowchart of an exemplary method for generating a supply signal;

FIG. 8 is a schematic embodiment of another exemplary embodiment of a driving device;

FIG. 9 is a schematic diagram of another exemplary embodiment of an energy management module;

FIG. 10 is a schematic diagram of another exemplary embodiment of a fuel cell;

FIG. 11 is a schematic flowchart of another exemplary control method; and

FIG. 12 is a schematic flowchart of another exemplary method for generating a supply signal.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

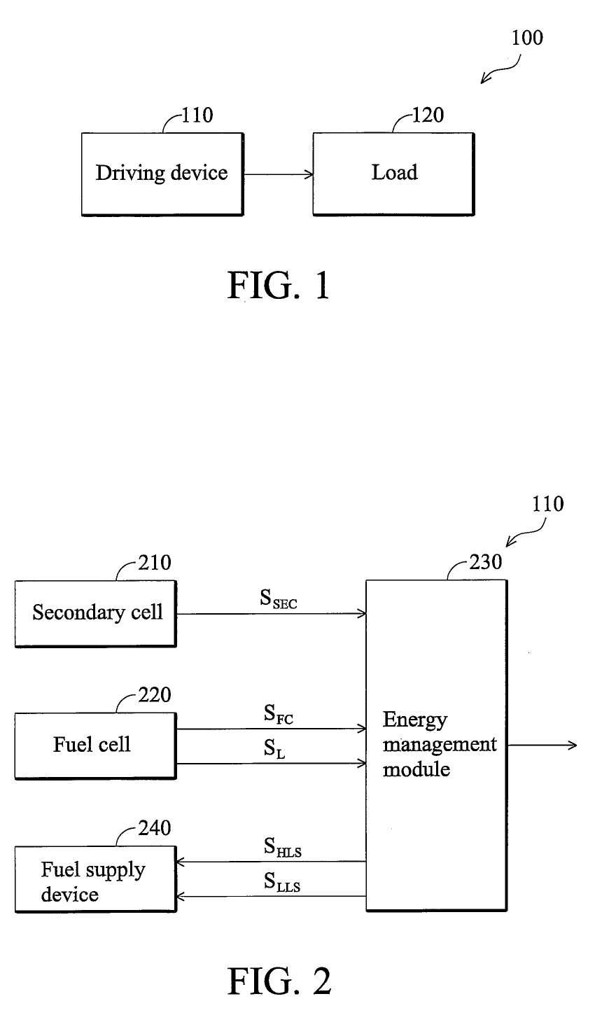

FIG. 1 is a schematic diagram of an exemplary embodiment of a driving system. The driving system 100 comprises a driving device 110 and a load 120. The load 120 receives a power signal provided by the driving device 110 to execute related functions. In this embodiment, the load 120 is a fan, a pump, a heater, or other electric equipment.

FIG. 2 is a schematic diagram of an exemplary embodiment of a driving device. The driving device 110 comprises a secondary cell 210, a fuel cell 220, an energy management module 230, and a fuel supply device 240. The secondary cell 210 is a rechargeable cell, for example, lithium ion secondary battery, nickel-cadmium cell, or nickel-metal-hydride battery. The energy management module 230 is coupled to the secondary cell 210, the fuel cell 220 and the fuel supply device 240 for driving the load 120 according to an electrical signal S_{SEC} generated by the secondary cell 210 or according to the electrical signal S_{FC} generated by the fuel cell 220. The energy management module 230 also generates two supply signals S_{HLS} and S_{LLS} to two fuel supply units (not shown) of different fuel concentrations, respectively, according to an electrical signals S_{FC} and a liquid level signal S_{L} from the fuel cell 220, thereby driving fuel pumps (not shown) in the fuel supply device 240 to supply fuels of different concentrations to the fuel cell 220, so that the fuel cell 200 can be supplied with pure fuel and wafer for electric-generation to maintain steady and long-term operation of the driving device 110. In this embodiment, the electrical signal S_{SEC} and S_{FC}, the liquid level signal S_{L}, the supply signals S_{HLS} and S_{LLS} can be, for example, signals in voltage or current forms.

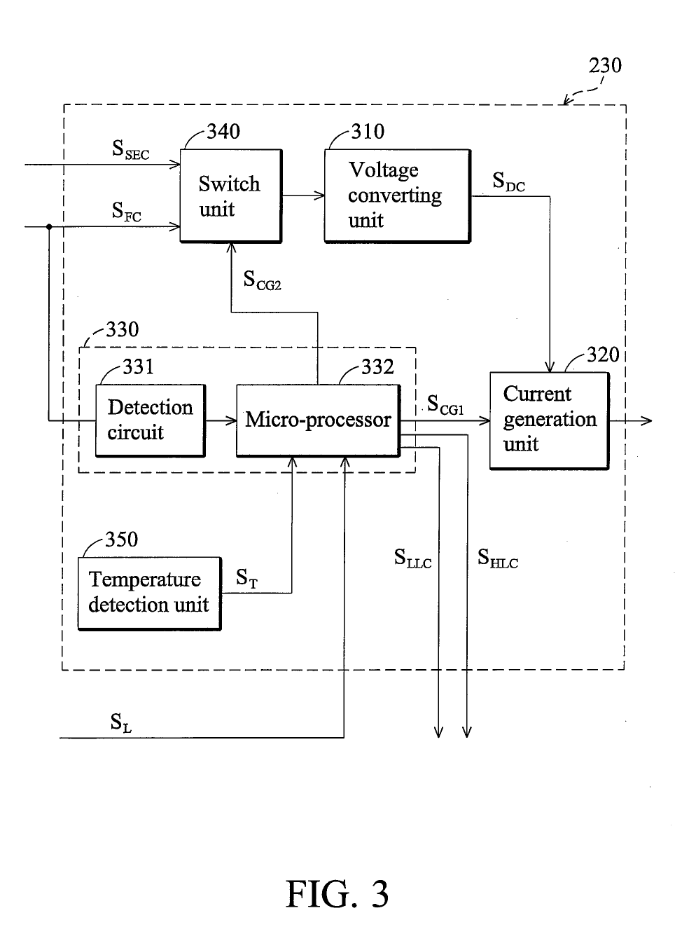

FIG. 3 is a schematic diagram of an exemplary embodiment of the energy management module. As shown in FIG.3, the energy management module 230 comprises a voltage converting unit 310 and a current generation unit 320. The voltage converting unit 310 transforms the electrical signal S_{SEC} or S_{FC} to generate a voltage signal S_{DC} and the current generation unit 320 receives the voltage signal S_{DC} and generates the different currents to the load according to a signal group S_{CG1}. In this embodiment, the energy management module 230 further includes a processing unit 330, a switch unit 340 and a temperature detection unit 350. The processing unit 330 includes a detection circuit 331 and a micro-processor 332. The temperature detection unit 350 detects an operating temperature within the fuel cell or an environment temperature of the fuel cell and can provide a temperature signal S_{T} to the micro-processor 332 in the processing unit 330. The detection circuit 331 detects the electrical signal S_{FC} from the fuel cell and generates a corresponding voltage signal or a current signal showing the electrical state of the fuel cell. The micro-processor 332 is coupled to the detection circuit 331 for receiving the above voltage signals or current signals. Thus, the micro-processor 332 can generate supply signals S_{LLC} and S_{HLC} to the fuel supply device 240 (referring to FIG. 2) according to the above electrical signal S_{FC}, the liquid level signal S_{L} and temperature signal S_{T} so that the fuel supply device 240 can provide fuel supplements to the fuel cell.

Detailed descriptions of the voltage converting unit 310, the current generation unit 320, the processing unit 330, the switch unit 340, and the temperature detection unit 350 and the detection circuit 331 within the processing unit 330 and the micro-processor 332 are disclosed in the R.O.C. patent application entitled “Driving device and energy management module” (filed on Oct. 26, 2007 with application no. 096140219), which belongs to the same applicant of the present application and are incorporated herein by reference.

In this embodiment, the processing unit 330 provides a signal group S_{CG1} to the current generation unit 320 according to the state (e.g. the electrical signal S_{FC}, the fuel level signal S_{L} and the temperature signal S_{T}) of the fuel cell. Thus, the current generation unit 320 can provide different currents to the load according to the state of the fuel cell. The provided current signal is proportional to fuel consumption within the fuel cell. Additionally, the processing unit 330 further provides a signal group S_{CG2} to the switch unit 340 according to the state of the fuel cell. Thus, the switch unit 340 transmits the electrical signals S_{FC} to the voltage converting unit 310 according to the aforementioned states of the fuel cell and provides fuel and water supplements to the fuel cell by the fuel supply device 240 (referring to FIG. 2) based on the supply signals S_{HLS} and S_{LLC} from the processing unit 330, thereby allowing stabilization of the voltage signal S_{DC} received by the current generation unit 320 and providing a stable current to the load.

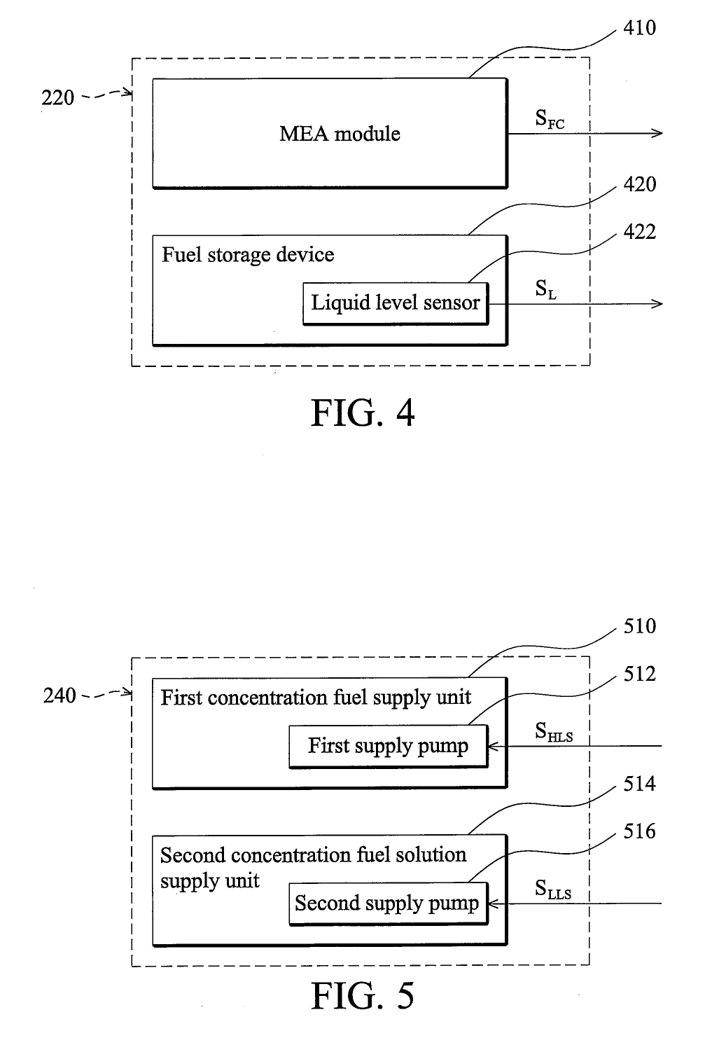

FIG. 4 is a schematic diagram of an exemplary embodiment of a fuel cell 220, including a membrane electrode assembly (MEA) module 410 and a fuel storage device 420. The fuel storage device 420 is connected with the MEA module 410 for storing and providing fuel solutions for electricity-generation of the MEA module 410. The fuel storage device 420 includes devices (not shown) for splitting and combining flows therein, thus transporting and recycling fuels into and out from the MEA module 410. The fuel storage device can be, for example, a tank with a liquid level sensor 422 disposed therein. The liquid level sensor 422 provides a level signal S_{L} to the micro-processor 332 of the processing unit 330 of the energy management module 230 according to to the liquid level state of the fuel storage device. Liquid level within the fuel storage device 420 includes, for example, a high high (HH) level, high (H) level, low (L) level, and a low low (LL) level defined from higher positions to lower positions therein. The HH level and LL level correspond to an almost full liquid level and an almost empty liquid level, respectively, and the H level and the L level is disposed between the above two levels and are dependent on a fuel solution concentration therewith. Typically, the fuel solution concentration of a liquid level between H and L level is about a fuel solution concentration that is capable of stable electricity-generation for the MEA module 410. Taking the fuel cells such as DMFCs as an example, a preferred methanol aqueous solution concentration is about 3˜10% for stable electricity-generation for the MEA module used therein. Thus, the processing unit 330 of the energy management module 230 is informed of a liquid level state in the fuel storage device of the fuel cell and generates appropriate supply signals S_{LLC} and S_{HLC} to the fuel supply device 240 according to the liquid level state and the electrical signal state from the fuel cell.

FIG. 5 is a schematic diagram of an exemplary embodiment of a fuel supply device. As shown in FIG. 5, the fuel supply device 240 includes a first concentration fuel supply unit 510 and a second concentration fuel supply unit 514. The first concentration fuel supply unit 510 can provide a predetermined amount of a first concentration fuel solution to the fuel storage device 240 of the fuel cell 220 according to the supply signal S_{HLC} and the second concentration fuel supply unit 510 can provide a predetermined amount of a second concentration fuel solution to the fuel storage device 240 of the fuel cell 220 according to the supply signal S_{LLS}. The first concentration fuel solution has a concentration greater than that of the second concentration fuel solution and the first concentration fuel solution supply unit 510 and the second concentration fuel solution supply unit 514 can operate individually, in combination, or in sequence to provide fuel solution supplements for the fuel storage unit 420. The first concentration fuel solution supply unit 510 and the second concentration fuel solution supply unit 514 can be a tank having a volume greater than that of the fuel storage unit 420 and this is beneficial for long term fuel supplements. A first supply pump 512 is disposed in the first concentration fuel solution supply unit 510 to supply the first concentration fuel solution according to the supply signal S_{HLS} and a second supply pump 514 is disposed in the second concentration fuel solution supply unit 514 to supply the second concentration fuel solution according to the supply signal S_{LLS}. The first and second supply pumps 512 and 514 can be, for example, static pumps.

In one embodiment, the first concentration fuel solution usually has a concentration typically over 50% (vol %) as a main source for supplying pure fuel (without water) which was consumed in the fuel solution and the second concentration fuel solution usually has a concentration typically less than 10% (vol %) as a main source for supplying water that was evaporated from the fuel solution. In a preferred embodiment, the first concentration fuel solution usually has a concentration of 100% (e.g. a fuel w/o water) and the second concentration fuel solution has a concentration of about 3˜10% to provide water supply, thereby fulfilling fuel and water supplies of the fuel cell. In this embodiment, the fuel cell can be a DMFC and the electricity-generation fuel solutions, the first concentration fuel solution, and the second concentration fuel solution are methanol aqueous solutions of previous concentrations or a pure methanol solution.

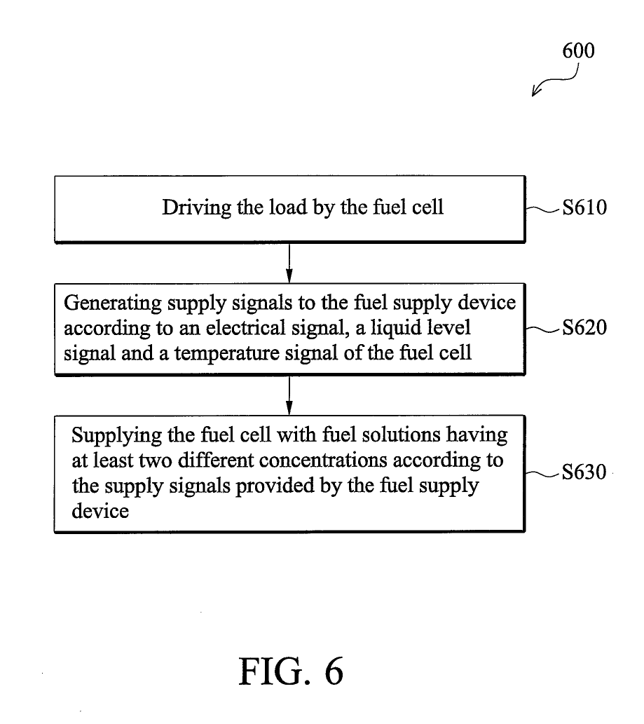

FIG. 6 is a schematic flowchart of an exemplary control method. In the control method 600, the load is driven by the fuel cell and the fuel cell can operate for a long-term and stable period by using the fuel solution supplements to the fuel cell controlled by the energy management module. As shown in FIG. 6, a secondary cell is first activated by a circuit (not shown) different from that shown in FIG. 3, to drive the supply pump in the second concentration supply unit to pump the second concentration fuel solution into the fuel storage device of the fuel cell to a HH level therein. At this time, the second concentration fuel solution is capable of activating the MEA module to generate electricity and allow stable functionality thereof (Step S610). In this step, the MEA module and the fuel storage device are empty and no fuel solution exists therein prior to activation of the secondary cell.

Next, after activation of the fuel cell, the MEA module generates a electrical signal to the processing unit in the energy management module, the level sensor in the fuel storage device of the fuel cell generates a liquid level signal to the processing unit, and the temperature detection unit in the energy management module generates a temperature signal to the processing unit. The processing unit thus generates a first signal and a second supply to the fuel supply device according to the above electrical signal, liquid level signal and temperature signal (Step S620).

Next, the first concentration fuel supply unit supplies a first amount of a first concentration fuel to the fuel storage device of the fuel cell according to the first signal and the second concentration fuel supply unit supplies a second amount of a second concentration fuel solution to the fuel storage device of the fuel cell according to the second signal. The first concentration fuel solution has a fuel concentration greater than that of the second concentration fuel solution. A first pump is disposed in the first concentration fuel supply unit and a second pump is disposed in the second concentration fuel supply unit to respectively supply the first and second fuel solutions according to the first and second signals, and the level and fuel solution concentration in the fuel storage device of the fuel cell is thus stably maintained and stable electricity-generation of the fuel cell is thus provided (Step S630).

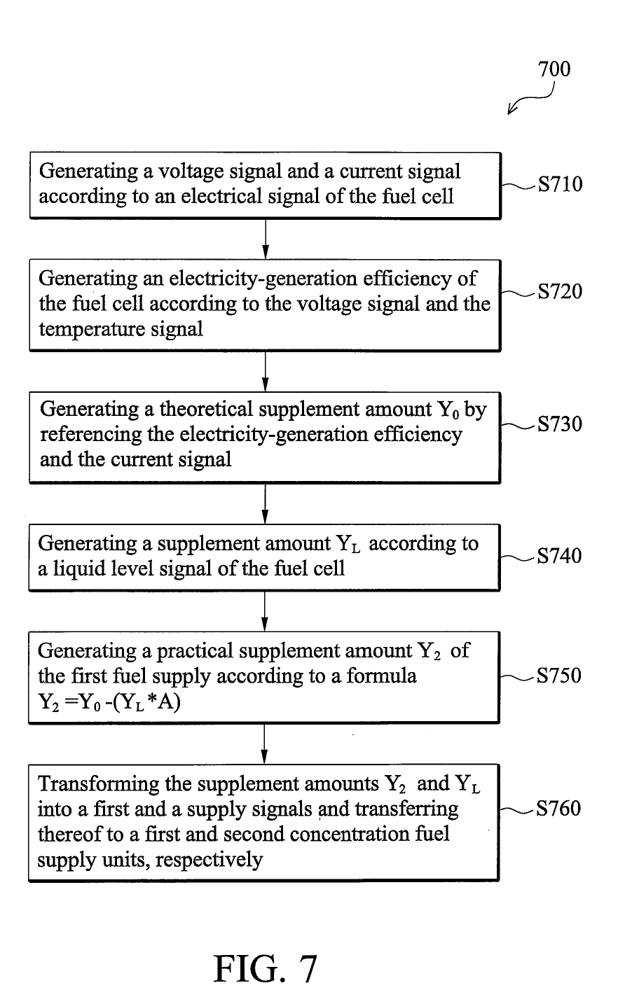

FIG. 7 is a schematic flowchart showing an embodiment of generation of the first and second signals to the processing unit as disclosed in the above step S620. First, the detection circuit in the processing unit generates a voltage signal and a current signal in sequence according to the electrical signal from the fuel cell (step S710).

Next, the micro-processor in the processing unit generates an electricity-generation efficiency of the fuel cell according to the voltage signal and the temperature signal from the temperature detection unit (step S720). The electricity-generation efficiency is obtained by checking the above voltage signal and the temperature signal with an experimental value obtained from an electricity-generation efficiency check list previously stored in the micro-processor.

Next, the micro-processor in the processing unit generates a supplement amount Y₀ of the first concentration fuel solution by referencing the electricity-generation efficiency and the current signals. The supplement amount Y₀ is a theoretical value but not a practical supplement amount for the fuel cell and is proportional to the fuel consumption of the fuel solution in the fuel cell (step S730).

Next, the micro-processor generates a supplement amount Y_{L} of the second concentration fuel solution for the fuel storage device according to the liquid level signal in the fuel storage supply device (step S740). According to the above liquid level signals, the second concentration supply amount may have various embodiments as follows:

a. if the level signal represents that the fuel solution in the fuel storage device is higher than the H level, the supplement amount Y_{L} of the second fuel concentration solution is set as 0 and no second concentration fuel solution will be supplied.

b. if the level signal represents that the fuel solution in the fuel storage device is lower than the L level, the supplement amount Y_{L} of the second fuel concentration solution is set as an amount for refilling a space from the L level to H level thereof, or

c. if the level signal represents that the fuel solution in the fuel storage device is at a level X between the H level and the L level, the supplement amount Y_{L} of the second concentration fuel solution can be provided as a predetermined amount every predetermined time period. The predetermined amount can be obtained and decided by experimentation.

Next, the micro-processor generates a practical supplement amount Y₂ of the first fuel supply according to a formula Y₂=Y₀−(Y_{L}*A). The symbol A represents a concentration ratio between the second concentration fuel solution and the first concentration fuel solution (step S750), as a known value.

Next, the micro-processor in the processing unit of the energy management module respectively transforms the above supplement amounts Y₂ and Y_{L} into the first and second signals and transfers thereof to the first and second concentration fuel supply units, respectively (step S760).

As described, the energy management module of the driving device is capable of stable performance control and management of the fuel cell therein and allows supplement of pure fuel and water to the fuel solution due to the disposition of the fuel supply device therein, thus providing stable electricity-generation efficiency of the fuel cell to the driving device for long term operation. Additionally, the disposed fuel supply device only adopts simply devices such as tanks and static pumps and the fuel solution concentration in the fuel cell can be controlled and managed by the energy management module, thus having advantages such as a simplistic system configuration and easy operation. Inconvenience and possible problems of artificially adjusting the fuel solution of the fuel cell are therefore prevented.

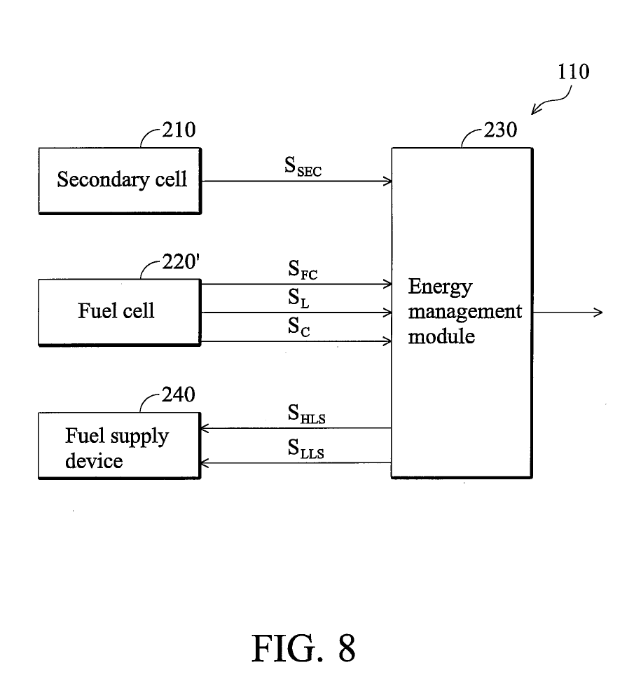

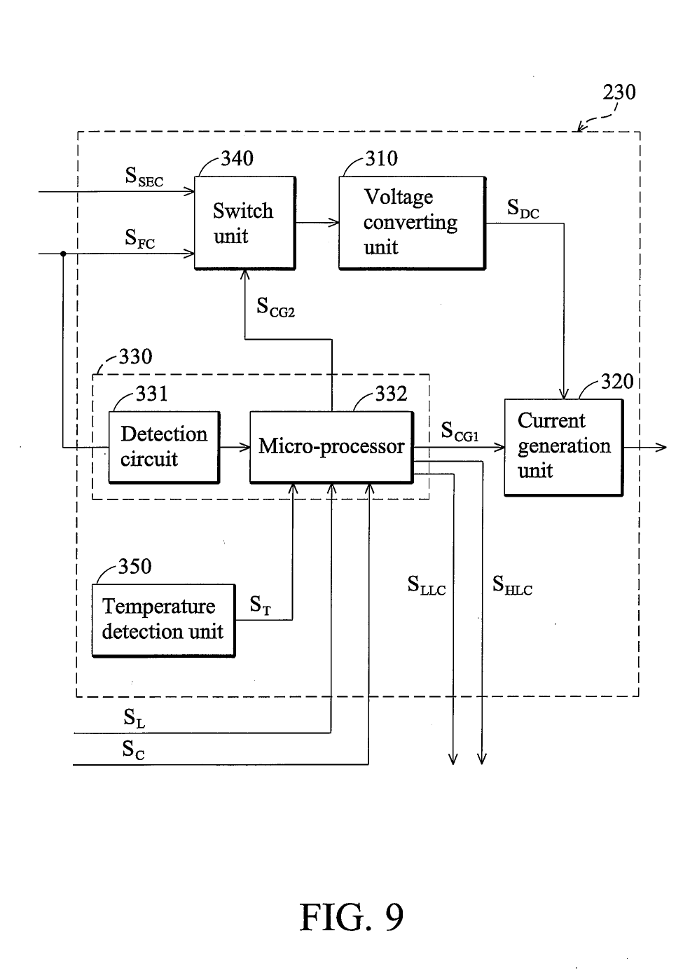

The driving device and the energy management module are not restricted by the embodiments disclosed by FIGS. 2 and 3. FIGS. 8 and 9 are driving device and energy management module according to various exemplary embodiments.

FIG. 8 shows a schematic diagram of another exemplary embodiment of a driving device 110 similar with that illustrated in FIG. 2. The only difference between the FIG. 8 and FIG. 2, is that the driving device 110 in FIG. 8 adopts a fuel cell 220′ different from that illustrated in FIG. 2. In this embodiment, the fuel cell 220′ not only generates an electrical signal S_{FC} and a liquid level signal S_{L}, but also generates a fuel concentration signal Sc to the energy management module 230. The energy management module 230 is coupled to the secondary cell 210, the fuel cell 220′ and the fuel supply device 240 for driving the load 120 according to an electrical signal S_{SEC} generated by the secondary cell 210 or according to the electrical signal S_{FC} generated by the fuel cell 220. The energy management module 230 also generates two supply signals S_{HLS} and S_{LLS} to two fuel supply units (not shown) of different fuel concentrations, respectively, according to an electrical signals S_{FC} and a liquid level signal S_{L} from the fuel cell 220′, thereby driving fuel pumps (not shown) in the fuel supply units to supply fuels of different concentrations to the fuel cell 220′, so that the fuel cell 220′ can supply pure fuel and wafer for electric-generation of the fuel cell 220′ to maintain steady and long-term operation of the driving device 110. In this embodiment, the electrical signal S_{SEC} and S_{FC}, the liquid level signal S_{L}, the fuel concentration signal S_{C}, the supply signals S_{HLS} and S_{LLS} can be, for example, signals in voltage or current forms.

FIG. 9 is a schematic diagram of an exemplary embodiment of the energy management module adopted in FIG. 8. As shown in FIG.9, the energy management module 230 comprises a voltage converting unit 310 and a current generation unit 320. The voltage converting unit 310 transforms the electrical signal S_{SEC} or S_{FC} to generate a voltage signal S_{DC} and the current generation unit 320 receives the voltage signal S_{DC} and generates the different currents to the load according to a signal group S_{CG1}. In this embodiment, the energy management module 230 further includes a processing unit 330, a switch unit 340 and a temperature detection unit 350. The processing unit 330 includes a detection circuit 331 and a micro-processor 332. The temperature detection unit 350 detects an operating temperature within the fuel cell or an environment temperature of the fuel cell and can provide a temperature signal S_{T} to the micro-processor 332 in the processing unit 330. The detection circuit 331 detects the electrical signal S_{FC} from the fuel cell and generates a corresponding voltage signal or a current signal showing the electrical state of the fuel cell. The micro-processor 332 is coupled to the detection circuit 331 for receiving the above voltage signals or current signals. In this embodiment, the micro-processor 332 can generate supply signals S_{LLC} and S_{HLC} to the fuel supply device 240 (referring to FIG. 2) merely according to the liquid level signal S_{L} and the fuel concentration signal S_{C} so that the fuel supply device 240 can provide fuel supplements to the fuel cell.

In this embodiment, the processing unit 330 provides a signal group S_{CG1} to the current generation unit 320 according to the state (e.g. the electrical signal S_{FC}, fuel concentration signal S_{C}, the fuel level signal S_{L} and the temperature signal S_{T}) of the fuel cell. Thus, the current generation unit 320 can provide different currents to the load according to the state of the fuel cell. The provided current signal is proportional to fuel consumption within the fuel cell. Additionally, the processing unit 330 further provides a signal group S_{CG2} to the switch unit 340 according to the state of the fuel cell. Thus, the switch unit 340 transmits the electrical signals S_{FC} to the voltage converting unit 310 according to the aforementioned states of the fuel cell and provides fuel and water supplements to the fuel cell by the fuel supply device 240 (referring to FIG. 2) based on the supply signals S_{HLS} and S_{LLC} from the processing unit 330, thereby allowing stabilization of the voltage signal S_{DC} received by the current generation unit 320 and providing a stable current to the load.

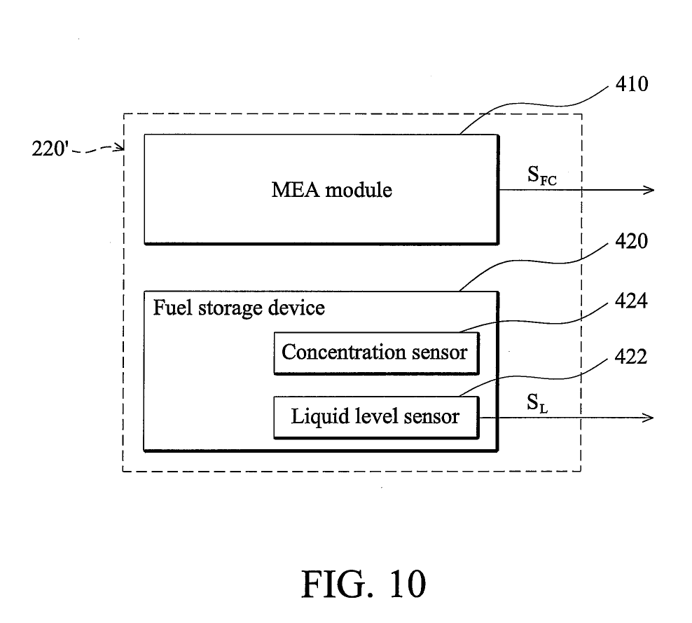

FIG. 10 is a schematic diagram of an exemplary embodiment of a fuel cell 220′, including a membrane electrode assembly (MEA) module 410 and a fuel storage device 420. The fuel storage device 420 is connected with the MEA module 410 for storing and providing fuel solutions for electricity-generation of the MEA module 410. The fuel storage device 420 includes devices (not shown) for splitting and combining flows therein, thus transporting and recycling fuels into and out from the MEA module 410. Fuel storage device can be, for example, a tank with a liquid level sensor 422 and a concentration sensor 424 disposed therein. The liquid level sensor 422 provides a level signal S_{L} to the micro-processor 332 of the processing unit 330 of the energy management module 230 according to the liquid level state of the fuel storage device and the concentration sensor 424 provides a fuel concentration signal S_{C} to the micro-processor 332 of the processing unit 330 of the energy management module 230 according to the fuel concentration of the fuel storage device. The liquid level within the fuel storage device 420 includes, for example, a high high (HH) level, high (H) level, low (L) level, and a low low (LL) level defined from higher positions to lower positions therein. The HH level and LL level correspond to an almost full liquid level and an almost empty liquid level, respectively, and the H level and the L level is disposed between the above two levels and are dependent on a fuel solution concentration therewith. Typically, the fuel solution concentration of a liquid level between H and L level is about a fuel solution concentration that capable of stable electricity-generation for the MEA module 410. Taking the fuel cells such as DMFCs for example, a preferred methanol aqueous solution concentration is about 3˜10% for stable electricity-generation for the MEA module used therein. Thus, the processing unit 330 of the energy management module 230 is informed of a fuel concentration state in the fuel storage device of the fuel cell and generates appropriate supply signals S_{LLC} and S_{HLC} to the fuel supply device 240 according to the fuel concentration signal S_{C}.

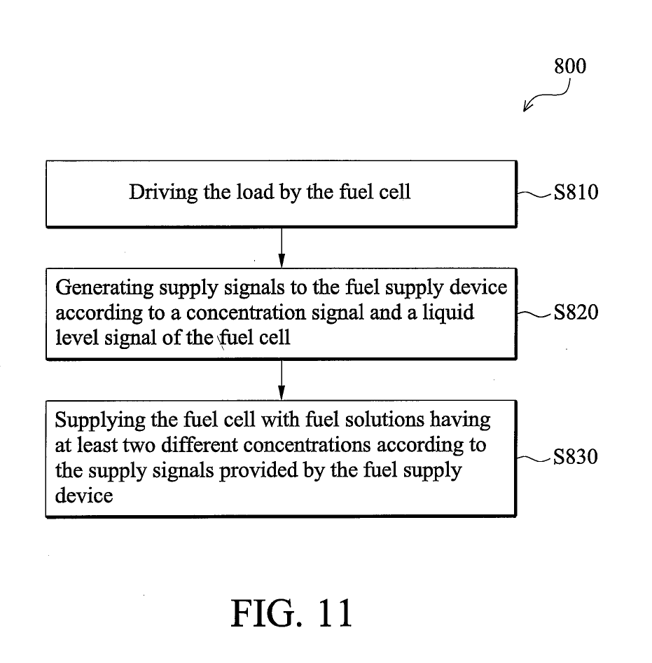

FIG. 11 is a schematic flowchart of an exemplary control method. In the control method 800, the load is driven by the fuel cell and the fuel cell can operate for a long-term and stable period by using the fuel solution supplements to the fuel cell controlled by the energy management module. As shown in FIG. 11, a secondary cell is first activated by a circuit (not shown) different from that shown in FIG. 9 to drive the supply pump in the second concentration supply unit to pump the second concentration fuel solution into the fuel storage device of the fuel cell to a HH level therein. At this time, the second concentration fuel solution is capable of activating the MEA module to generate electricity and allow stable functionality thereof (Step S810). In this step, the MEA module and the fuel storage device are empty and no fuel solution exists therein prior to activation of the secondary cell.

Next, after activation of the fuel cell, the concentration sensor in the fuel storage device may generate a fuel concentration signal to the micro-processor if it detects that the fuel concentration is below a predetermined set value. The level sensor in the fuel storage device of the fuel cell generates a liquid level signal to the micro-processor in the processing unit, and the temperature detection unit in the energy management module generates a temperature signal to the processing unit. The processing unit thus generates a first signal and a second signal to the fuel supply device according to the above concentration signal and liquid level signal (Step S820).

Next, the first concentration fuel supply unit supplies a first amount of a first concentration fuel to the fuel storage device of the fuel cell according to the first signal and the second concentration fuel supply unit supplies a second amount of a second concentration fuel solution to the fuel storage device of the fuel cell according to the second signal. The first concentration fuel solution has a fuel concentration greater than that of the second concentration fuel solution. A first pump is disposed in the first concentration fuel supply unit and a second pump is disposed in the second concentration fuel supply unit to respectively supply the first and second fuel solutions according to the first and second signals, and the level and fuel solution concentration in the fuel storage device of the fuel cell is thus stably maintained and stable electricity-generation of the fuel cell is thus provided (Step S830).

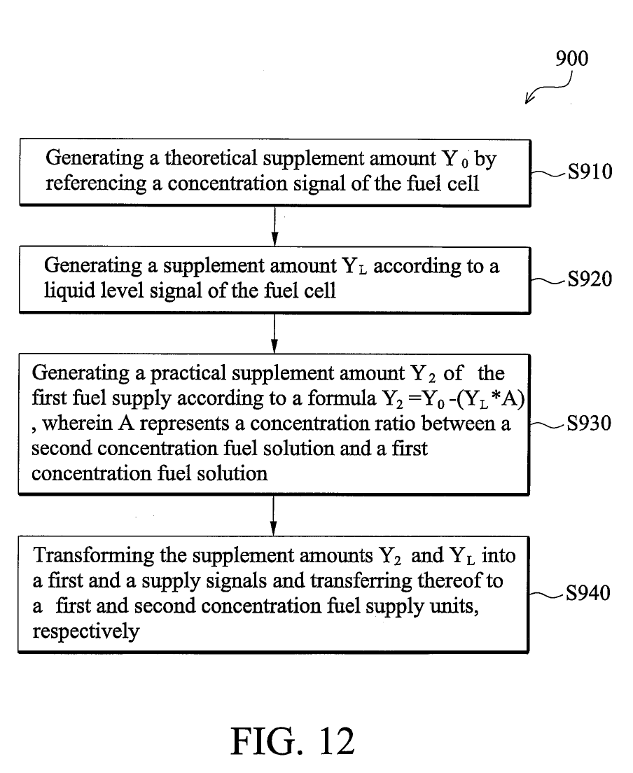

FIG. 12 is a schematic flowchart showing an embodiment of a method 900 for generating of the first and second signals to the processing unit as disclosed in above step S820.

First, the concentration sensor in the fuel storage device of the fuel cell generates a fuel concentration signal to the micro-processor when it detects that the fuel concentration is below a predetermined set value and the level sensor in the fuel storage device of the fuel cell generates a liquid level signal to the micro-processor in the processing unit, thereby the micro-processor in the processing unit generates a supplement amount Y₀ of the first concentration fuel solution (step S910). The supplement amount Y₀ is a theoretical value but not a practical supplement amount for the fuel cell and is proportional to the fuel consumption of the fuel solution in the fuel cell.

Next, the micro-processor generates a supplement amount Y_{L} of the second concentration fuel solution to the fuel storage device according to the liquid level signal in the fuel storage supply device (step S920). According to the above liquid level signals, the second concentration supply amount may have various embodiments as follows:

a. if the level signal represents that the fuel solution in the fuel storage device is higher than the H level, the supplement amount Y_{L} of the second fuel concentration solution is set as 0 and no second concentration fuel solution will be supplied.

b. if the level signal represents that the fuel solution in the fuel storage device is lower than the L level, the supplement amount Y_{L} of the second fuel concentration solution is set as an amount for refilling a space from the L level to H level thereof; or

c. if the level signal represents that the fuel solution in the fuel storage device is at a level X between the H level and the L level, the supplement amount Y_{L} of the second concentration fuel solution can be provided as a predetermined amount every predetermined time period. The predetermined amount can be obtained and decided by experimentation.

Next, the micro-processor generates a practical supplement amount Y₂ of the first fuel supply according to a formula Y₂=Y₀−(Y_{L}*A). The symbol A represents a concentration ratio between the second concentration fuel solution and the first concentration fuel solution (step S930), as a known value.

Next, the micro-processor in the processing unit of the energy management module respectively transforms the above supplement amounts Y₂ and Y_{L} into the first and second signals and transfers thereof to the first and second concentration fuel supply units, respectively (step S940).

As described, the energy management module of the driving device is capable of stable performance control and management of the fuel cell and allows supplement of pure fuel and water to the fuel solution due to the disposition of the fuel supply device therein, thus providing stable electricity-generation efficiency of the fuel cell to the driving device for long term operation. Additionally, the disposed fuel supply device only adopts simply devices such as tanks and static pumps and the fuel solution concentration in the fuel cell can be controlled and managed by the energy management module, thus having advantages such as a simplistic system configuration and easy operation. Inconvenience and possible problems of artificially adjusting the fuel solution of the fuel cell are therefore prevented.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A driving device for driving a load, comprising:
a secondary cell;
a fuel cell;
a fuel supply device; and
an energy management module coupled to the secondary cell, the fuel cell, and the fuel supply device for generating a current signal to the load and a first and a second signal to the fuel supply device according to an electrical signal and a liquid level signal of the fuel cell, and driving the fuel supply device to supply a fuel solution to the fuel cell.

2. The driving device as claimed in claim 1, wherein the fuel cell comprises:
a membrane electrode assembly (MEA) module; and
a fuel storage device for providing the MEA module with the fuel solution for generating the electrical signal.

3. The driving device as claimed in claim 2, wherein the fuel storage device further comprises a liquid level sensor, and the liquid level sensor provides the level signal according to a liquid level state of the fuel solution in the fuel storage device.

4. The driving device as claimed in claim 1, wherein the energy management module comprises:
a processing unit; and
a temperature detection unit, wherein the temperature detection unit generates the temperature signal to the processing unit according to a temperature state of the fuel cell and the processing unit generates the first and second signals to the fuel supply device according to the electrical signal, the liquid level signal and the temperature signal of the fuel cell.

5. The driving device as claimed in claim 1, wherein the fuel supply device comprising:
a first concentration fuel supply unit; and
a second concentration fuel supply unit, wherein the first concentration fuel supply unit supplies a first concentration fuel solution to the fuel cell according to the first signal, and the second concentration fuel supply unit provides a second concentration fuel solution to the fuel cell according to the second signal, and the first concentration fuel solution has a fuel concentration greater than that of the second concentration fuel solution.

6. The driving device as claimed in claim 5, wherein the first concentration fuel solution has a fuel concentration greater than 50% (vol %) and the second concentration fuel solution has a fuel concentration less than 10% (vol %).

7. The driving device as claimed in claim 5, wherein the first concentration fuel solution has a fuel concentration of 100% (vol %) and the second concentration fuel solution has a fuel concentration of about 3˜10% (vol %).

8. The driving device as claimed in claim 5, wherein the first and second concentration solutions are solutions comprising methanol and water.

9. The driving device as claimed in claim 5, wherein a first pump is disposed in the first concentration supply unit for supplying the first concentration fuel solution according to the first signal and a second pump is disposed in the second concentration supply unit for supplying the second concentration fuel solution according to the second signal.

10. An energy management module coupled to a secondary cell, a fuel cell and a fuel supply device for driving a load and supplying the fuel cell, comprising:
a processing unit; and
a temperature sensing unit, wherein the temperature sensing unit provides the processing unit a temperature signal according to a temperature state of the fuel cell and the processing unit generates a first and a second signal to the fuel supply device according to the electrical signal, the liquid level signal and the temperature signal of the fuel cell.

11. The energy management module as claimed in claim 10, wherein the fuel supply device comprises:
a detection circuit for sensing the electrical signal from the fuel cell; and
a micro-processor coupled to the detection circuit and the temperature detection unit for generating the first and second signals to the fuel supply device according to the electrical signal, the liquid level signal, and the temperature signal.

12. The energy management module as claimed in claim 11, wherein the fuel supply device comprises:
a first concentration fuel supply unit; and
a second concentration fuel supply unit, wherein the first concentration fuel supply unit supplies a first concentration fuel solution to the fuel cell according to the first signal, and the second concentration fuel supply unit supplies a second concentration fuel solution to the fuel cell according to the second signal, and wherein the first concentration fuel solution has a fuel concentration greater than that of the second concentration fuel solution.

13. The energy management module as claimed in claim 12, wherein the first and second concentration fuel solutions have a concentration ratio A therebetween, the detection circuit generates a voltage signal and a current signal in sequence according to the electrical signal, and the micro-processor generates an efficiency of the fuel cell and generates a theory value Y₀ for supplying the first concentration fuel solution, and a supplement amount Y_{L} for supplying the second concentration fuel solution, and wherein a supplement amount Y₂ practically supplies the first concentration fuel solution according to a formula Y₂=Y₀−(Y_{L}*A).

14. The energy management module as claimed in claim 13, wherein a first supply pump is disposed in the first concentration supply unit for providing the first concentration fuel solution according to the first signal and a second supply pump is disposed in the second concentration supply unit for providing the second concentration fuel solution according to the second signal, and wherein the micro-processor respectively transforms the supply amount Y₂ and the supply amount Y_{L} as the first and second signals for the first and second supply pumps.

15. The energy management module as claimed in claim 12, wherein the first concentration fuel solution has a concentration greater than 50% (vol %) and the second concentration fuel solution has concentration less than 10% (vol %).

16. The energy management module as claimed in claim 15, wherein the first concentration fuel solution has a concentration of 100% (vol %) and the second concentration fuel solution has concentration of about 3˜10% (vol %).

17. The energy management module as claimed in claim 12, wherein the first and second concentration solutions are solutions comprising methanol and water.

18. A driving device for driving a load, comprising:
a secondary cell;
a fuel cell;
a fuel supply device; and
an energy management module coupled to the secondary cell, the fuel cell, and the fuel supply device and generating a current signal to the load, and generating a first and a second signal to the fuel supply device according to a fuel concentration signal and a liquid level signal from the fuel cell, driving the fuel supply device to provide fuel supply to the fuel cell.

19. The driving device as claimed in claim 18, wherein the fuel cell comprises:
a membrane electrode assembly (MEA) module; and
a fuel storage device for providing the MEA module a fuel solution, wherein a liquid level sensor and a fuel concentration sensor are disposed in the fuel storage device and the liquid level sensor generates the level signal according to a liquid level state of the fuel solution in the fuel storage device and the fuel concentration sensor generates the concentration signal according to a fuel concentration state of the fuel solution in the fuel storage device.

20. The driving device as claimed in claim 18, wherein the energy management module comprises:
a processing unit for generating the first and second signals to the fuel supply device according to the fuel concentration signal and the liquid level signal.

21. The driving device as claimed in claim 18, wherein the fuel supply device comprises:
a first concentration fuel supply unit; and
a second concentration fuel supply unit, wherein the first concentration fuel supply unit provides a first concentration fuel solution to the fuel cell according to the first signal, and the second concentration fuel supply unit provides a second concentration fuel solution to the fuel cell according to the second signal, and wherein the first concentration fuel cell has a concentration greater than that of the second concentration fuel cell.

22. The driving device as claimed in claim 21, wherein the first concentration fuel solution has a concentration greater than 50% (vol %) and the second concentration fuel solution has concentration less than 10% (vol %).

23. The driving device as claimed in claim 21, wherein the first concentration fuel solution has a concentration of 100% (vol %) and the second concentration fuel solution has concentration of about 3˜10% (vol %).

24. The driving device as claimed in claim 21, wherein the first and second concentration solutions are solutions comprising methanol and water.

25. The driving device as claimed in claim 21, wherein a first pump is disposed in the first concentration supply unit for providing the first concentration fuel solution according to the first signal and a second pump is disposed in the second concentration supply unit for providing the second concentration fuel solution according to the second signal.

26. An energy management module coupled to a secondary cell, a fuel cell and a fuel supply device for driving a load and supplying the fuel supply device, comprising:
a processing unit for generating a first and a second signal to the fuel supply device according to a fuel concentration signal and a liquid level signal from the fuel cell.

27. The energy management module as claimed in claim 26, wherein the processing unit comprises a micro-processor for generating the first and second signals to the fuel supply device according to the fuel concentration signal and the liquid level signal.

28. The energy management module as claimed in claim 26, wherein the fuel supply device comprises:
a first concentration fuel supply unit; and
a second concentration fuel supply unit, wherein the first concentration fuel supply unit provides a first concentration fuel solution to the fuel cell according to the first signal, and the second concentration fuel supply unit provides a second concentration fuel solution to the fuel cell according to the second signal, and wherein the first concentration fuel cell has a concentration greater than that of the second concentration fuel cell.

29. The energy management module as claimed in claim 28, wherein the first and second concentration fuel solutions have a concentration ratio A therebetween, the microprocessor generates a theory value Y₀ for supplying the first concentration fuel solution, and a supplement amount Y_{L} for supplying the second concentration fuel solution, and wherein a supplement amount Y₂ practically supplies the first concentration fuel solution according to a formula Y₂=Y₀−(Y_{L}*A).

30. The energy management module as claimed in claim 28, wherein a first supply pump is disposed in the first concentration supply unit for providing the first concentration fuel solution according to the first signal and a second supply pump is disposed in the second concentration supply unit for providing the second concentration fuel solution according to the second signal, and the micro-processor respectively transforms the supplement amount Y₂ and the supplement amount Y_{L} as the first and second signals for the first and second supply pumps.

31. The energy management module as claimed in claim 30, wherein the first concentration fuel solution has a concentration greater than 50% (vol %) and the second concentration fuel solution has concentration less than 10% (vol %).

32. The energy management module as claimed in claim 31, wherein the first concentration fuel solution has a concentration of 100% (vol %) and the second concentration fuel solution has concentration of about 3˜10% (vol %).

33. The energy management module as claimed in claim 28, wherein the first and second concentration solutions are solutions comprising methanol and water.
